(19) United States
(12) Patent Application Publication
(10) Pub. No.: US 2007/0206540 A1
(43) Pub. Date: Sep. 6, 2007

(54) Apparatus for Reducing Intermodulation Distortion in a Cdma2000 System

(76) Inventor: Ha Young Lim, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 10/554,840

(22) PCT Filed: May 28, 2004
(86) PCT No.: PCT/KR04/01267

§ 371 Date: Mar. 8, 2007

(30) Foreign Application Priority Data
May 29, 2003 (KR) 10-2003-0034423

(51) Int. Cl. H04B 1/40

(52) U.S. Cl. 370/335

(57) ABSTRACT

The present invention relates to an apparatus for minimizing intermodulation of local signals in a transceiver when adjacent frequencies are used as the local signals in a transceiver board having more than two built-in synthesizers. The apparatus comprises: a first mixer for mixing a first signal having a frequency to be lowered and a lower side local signal in a low frequency band and for outputting a first mixed signal; and a second mixer for mixing a second signal having a frequency to be lowered and an upper side local signal in a high frequency band and for outputting a second mixed signal, wherein the frequency of the second signal is adjacent to the frequency of the first signal, and the upper side local signal has a higher frequency than the lower side local signal.

### TECHNICAL FIELD

The present invention relates to an apparatus for reducing intermodulation of local signals in a transceiver of a base transceiver system (BTS) used in Code Division Multiple Access (CDMA) technology, and more particularly to an apparatus for minimizing intermodulation of local signals in a transceiver when adjacent frequencies are used as the local signals in a transceiver board having more than two built-in synthesizers.

### BACKGROUND ART

In general, a CDMA mobile communication system, such as CDMA 2000, comprises a mobile station for providing mobile communication service, a base transceiver system (BTS) for interfacing voice and data between the mobile station and a wireless communication system, a controlling station for interfacing voice and data between the BTS and a wire communication system, a mobile switching system coupled to the controlling station and switching the voice and the data.

In a CDMA mobile communication system comprising the above mentioned elements, down-conversion or up-conversion of frequencies are performed within the BTS using a local signal in order to process a forward signal and a backward signal.

Specifically, a synthesizer and a transceiver are combined on one board as a transceiver integrated board.

The transceiver integrated board has more than two synthesizers and, in order to convert frequencies, uses a lower side local signal as a local signal for mixing.

In the case of using signals of frequencies that are adjacent to each other in one board and using the same lower side local signal, preventing intermodulation between adjacent local signals that have higher power than the main signal is difficult.

Namely, local signals of frequencies that are adjacent to each other in one board suffer from intermodulation due to use of the same lower side local signal.

The intermodulation distorts the signals, and thus the quality of the transmission/reception is degraded.

### DISCLOSURE OF THE INVENTION

Accordingly, the present invention is provided to solve the above problem. The object of the present invention is to provide an apparatus for reducing intermodulation of local signals in a transceiver, which can minimize the intermodulation between local signals having adjacent frequencies in a transceiver having more than two synthesizers.

In accordance with an embodiment of the present invention, an apparatus is provided including at least two built-in mixers.

The apparatus comprises:

a first mixer for mixing a first signal having a frequency to be lowered and a lower side local signal in a low frequency band and for outputting a first mixed signal; and

a second mixer for mixing a second signal having a frequency to be lowered and an upper side local signal in a high frequency band and for outputting a second mixed signal, wherein the frequency of the second signal is adjacent to the frequency of the first signal, and the upper side local signal has a higher frequency than the lower side local signal.

In accordance with another embodiment of the present invention, an apparatus is provided including at least two built-in mixers for performing multi-frequency assignment (FA).

The apparatus comprises:

a first mixer and second mixer for respectively mixing a first signal and a second signal with a first lower side local signal fLo1, wherein the first and the second signals have frequencies to be lowered, and the lower side local signal has a frequency in a low frequency band;

a third mixer for mixing a signal outputted from the first mixer and a second lower side local signal and for outputting a first resulting signal, wherein the second lower side local signal has a frequency in the low frequency band; and

a fourth mixer for mixing a signal outputted from the second mixer and an upper side local signal and for outputting a second resulting signal, wherein the upper side local signal has a higher frequency than the second lower side local signal in the low frequency band.

### BRIEF DESCRIPTION OF DRAWINGS

FIG. 1 shows an apparatus for reducing intermodulation of local signals in a transceiver; and

FIG. 2 shows a circuit for another embodiment of the present invention.

### BEST MODE FOR CARRYING OUT THE INVENTION

An embodiment of the present invention will be described with reference to the accompanying drawings according to the above-identified technical scope of the present invention.

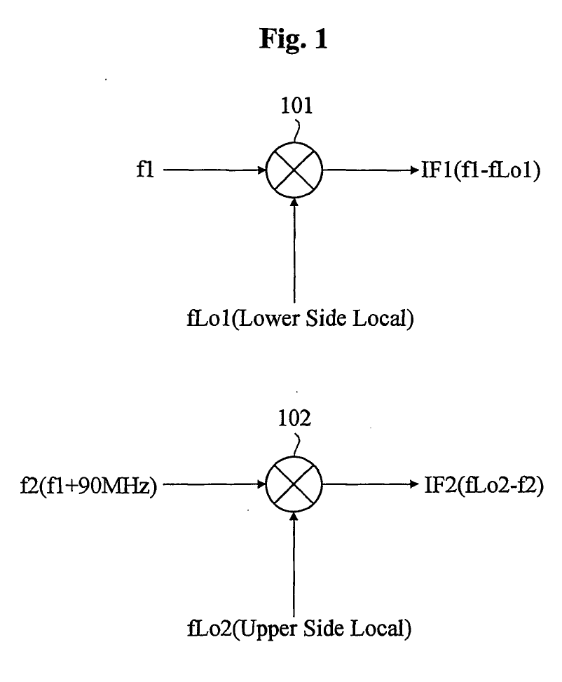

FIG. 1 shows an apparatus for reducing intermodulation of local signal in a transceiver.

As shown in FIG. 1, the apparatus for reducing intermodulation of local signals in a transceiver comprises: first mixer 101 for mixing first signal f1 having a frequency to be lowered and lower side local signal fLo1 in a low frequency band and for outputting first mixed signal f1−fLo1; and second mixer 101 for mixing second signal f2 having a frequency to be lowered and upper side local signal fLo2 in a high frequency band and for outputting second mixed signal fLo2−f2; wherein the frequency of second signal f2 is adjacent to the frequency of first signal f1, and upper side local signal fLo2 has a higher frequency than lower side local signal fLo1.

In the apparatus comprising the elements mentioned above according to a first embodiment of the present invention, first mixer 101 mixes first signal f1 having the frequency to be lowered and lower side local signal fLo1, and thus signal fl1−fLo1 is outputted from first mixer 101 as first resulting signal IF1.

Also, second mixer 102 mixes second signal f2(f1+90 MHz) having the frequency to be lowered and upper side local signal fLo2 having a higher frequency than lower side local signal fLo1, and thus signal fLo2−f2 is outputted from second mixer 102 as second resulting signal IF2.

If a transceiver board is designed as mentioned above, the frequency separation between the local signals becomes 90 MHz+IF1+EF2.

In conclusion, the difference between the local frequencies obtained by the method in accordance with the present invention of adopting the lower side local signal and the upper side local signal, and a conventional method of adopting both lower side local signals is 2*IF2. It is possible that a spectrum inversion may arise in the case of using an upper side local signal. However, the problem of spectrum inversion can be solved by normal performance of modulation/demodulation in the cases of performing an up-conversion and a down-conversion in a digital unit.

Therefore, the intermodulation of local signals may be reduced by increasing the frequency separation between the local signals.

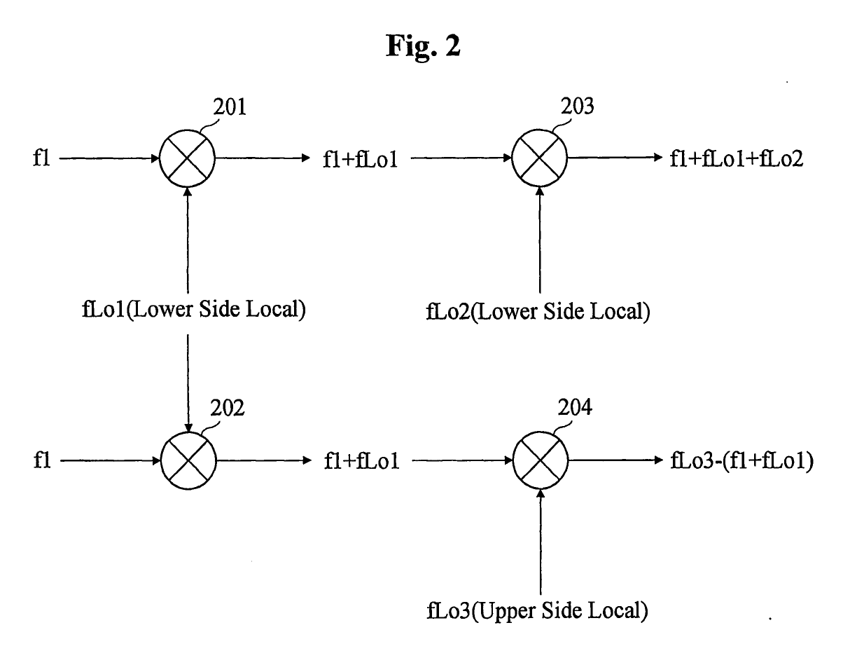

FIG. 2 shows an apparatus for reducing intermodulation of local signals in a transceiver in accordance with another embodiment of the present invention.

As shown in FIG. 2, the apparatus for reducing intermodulation of local signals in a transceiver comprises: first mixer and second mixer 201 and 202 for respectively mixing first signal f1 and second signal f2 with first lower side local signal fLo1, wherein the first and the second signals have frequencies to be lowered, and the lower side local signal has a frequency in a low frequency band; third mixer 203 for mixing signal f1+fLo1 outputted from first mixer 201 and second lower side local signal fLo2 and for outputting first resulting signal f1+fLo1+fLo2, wherein the second lower side local signal has a frequency in the low frequency band; fourth mixer 204 for mixing signal f1+fLo1 outputted from second mixer 202 and upper side local signal fLo3 and for outputting second resulting signal fLo3−(f1+fLo1), wherein the upper side local signal has a higher frequency Mal the second lower side local signal in the low frequency band.

Operation of the apparatus comprising the elements mentioned above according to another embodiment of the present invention will be described.

First mixer and second mixer 201 and 202 mix, respectively, first signal f1 and second signal f2 having frequencies to be lowered with first lower side local signal fLo1 having a frequency in the low frequency band, and thus signal f1+fLo1 is outputted from the first mixer and the second mixer.

Third mixer 203 mixes signal f1+fLo1 outputted from first mixer 201 and second lower side local signal fLo2 in the low frequency band, and thus outputs first resulting signal f1+fLo1+fLo2.

Fourth mixer 204 mixes signal f1+fLo1 outputted from second mixer 202 and upper side local signal fLo3 having a higher frequency than the lower side local signal in the low frequency band, and thus outputs second resulting signal fLo3−(f1+fLo1).

Likewise, in the case of operating a multi-frequency assignment (FA), the intermodulation of local signals may be minimized by increasing the frequency separation between the local signals.

### INDUSTRIAL APPLICABILITY

According to the present invention, the intermodulation of local signals may be minimized by using lower side local and upper side local signals having relatively large frequency separation as local signals.

1. An apparatus including at least two built-in mixers, the apparatus comprising:
a first mixer 101 for mixing a first signal f1 having a frequency to be lowered and a lower side local signal fLo1 in a low frequency band and outputting a first mixed signal f1−fLo1; and
a second mixer for mixing a second signal f2 having a frequency to be lowered and an upper side local signal fLo2 in a high frequency band and outputting a second mixed signal fLo2−f2, wherein the frequency of the second signal f2 is adjacent to the frequency of the first signal f1, and the upper side local signal fLo2 has a higher frequency than the lower side local signal fLo1.

2. An apparatus including at least two built-in mixers for performing multi-frequency assignment (FA), the apparatus comprising:
a first mixer and second mixer 201 and 202 for respectively mixing a first signal f1 and a second signal f2 with a first lower side local signal fLo1, wherein the first and the second signals have frequencies to be lowered, and the lower side local signal has a frequency in a low frequency band;
a third mixer 203 for mixing a signal f1+fLo1 outputted from the first mixer 201 and a second lower side local signal fLo2 and for outputting a first resulting signal f1+fLo1+fLo2, wherein the second lower side local signal has a frequency in the low frequency band; and
a fourth mixer 204 for mixing a signal f1+fLo1 outputted from the second mixer 202 and an upper side local signal fLo3 and for outputting a second resulting signal fLo3−f1+fLo1), wherein the upper side local signal has a higher frequency than the second lower side local signal in the low frequency band.
